(19) United States
(12) Patent Application Publication
(10) Pub. No.: US 2017/0031948 A1
(43) Pub. Date: Feb. 2, 2017

(54) FILE SYNCHRONIZATION METHOD, SERVER, AND TERMINAL

(71) Applicant: HUAWEI TECHNOLOGIES CO., LTD., Shenzhen (CN)

(72) Inventor: Kaifu XU, Shenzhen (CN)

(73) Assignee: HUAWEI TECHNOLOGIES CO., LTD., Shenzhen (CN)

(21) Appl. No.: 15/293,828

(22) Filed: Oct. 14, 2016

Related U.S. Application Data
(63) Continuation of application No. PCT/CN2014/075349, filed on Apr. 15, 2014.

(51) Int. Cl. G06F 17/30

(52) U.S. Cl. CPC G06F 17/30174; H04L 67/42

(57) ABSTRACT

The present application provides a file synchronization method, a server, and a terminal. The method includes: receiving a file synchronization request sent by a terminal; responding to the file synchronization request, and searching data that is of various versions of the file and stored in a server for first record data, where the first record data includes an operation record generated for the file of a predetermined version after the terminal latest synchronizes the file; and sending the first record data to the terminal, so that the terminal obtains, according to the first record data and second record data in the terminal, an operation that should be performed by the terminal, where the second record data includes an operation record performed on the file after the terminal latest synchronizes the file. Then a time for file synchronization can be shortened, consumption of a network resource can be reduced.

### CROSS-REFERENCE TO RELATED APPLICATIONS

This application is a continuation application of International Patent Application No. PCT/CN2014/075349, filed on Apr. 15, 2014, the disclosure of which is hereby incorporated by reference in its entirety.

### TECHNICAL FIELD

The present application relates to the field of data synchronization technologies, and in particular, to a file synchronization method, a server, and a terminal.

### BACKGROUND

As Internet technologies develop and an informatization degree improves, to improve convenience and security of data management, an end user may synchronously back up file data in a terminal to another terminal by using a data synchronization technology, so as to implement management of same file data on different terminals. Currently, two manners are commonly used for file data synchronization. In manner 1, a terminal queries a server side for a directory structure of file data, compares a directory structure of file data stored in the terminal with that of the file data stored on the server side, and updates the file data in the terminal according to a difference between the directory structures of these two parties. In manner 2, a terminal downloads a directory structure of file data stored on a server side, compares a directory structure of file data stored in the terminal with that of the file data stored on the server side, and updates the file data in the terminal according to a difference between the directory structures of these two parties.

In manner 1, each time when the terminal synchronizes the file data, the terminal needs to perform multiple interactions with the server side, transverse each layer of a directory, a subdirectory, and a subfile that are of the file data stored on the server side, and then compare the directory structure of the file data stored on the server side with the directory structure of the file data stored in the terminal. Therefore, it takes a relative long time for synchronization. In manner 2, before synchronization, the terminal needs to download, to the terminal, the directory structure of the file data stored on the server side. When a size of the directory structure of the file data is relatively large, downloading the directory structure not only increases pressure on bandwidth but also consumes a relatively long time, which affects synchronization efficiency.

### SUMMARY

The present application provides a file synchronization method, a server, and a terminal, which can improve efficiency in synchronizing file data, and reduce consumption of a network resource and pressure on bandwidth during file data synchronization.

According to a first aspect, the present application provides a file synchronization method, including:

receiving a file synchronization request sent by a terminal;

responding to the file synchronization request, and searching data that is of various versions of a file and stored in a server for first record data, where the first record data includes an operation record generated for the file of a predetermined version after the terminal latest synchronizes the file; and

sending the first record data to the terminal, so that the terminal obtains, according to the first record data and second record data in the terminal, an operation that should be performed by the terminal, where the second record data includes an operation record performed on the file after the terminal latest synchronizes the file.

With reference to the first aspect, in a first possible implementation manner, the file synchronization request includes a version number of the file that is latest synchronized by the terminal and a latest version number for current synchronization; and

the first record data includes all operation records generated for the file of the predetermined version after the terminal latest synchronizes the file, where a version number of the predetermined version is later than the version number of the file that is latest synchronized by the terminal and is earlier than or equal to the latest version number for the current synchronization.

With reference to the first aspect, in a second possible implementation manner, the file synchronization request includes a version number of the file that is latest synchronized by the terminal and a quantity threshold; and

the first record data includes a predetermined quantity of operation records successively generated for the file of the predetermined version after the terminal latest synchronizes the file, where a version number of the predetermined version is later than the version number of the file that is latest synchronized by the terminal, and a value of the predetermined quantity is equal to the quantity threshold.

With reference to the first aspect, and the first and the second possible implementation manners of the first aspect, in a third possible implementation manner, after the sending the first record data to the terminal, the method further includes:

receiving identification information of the terminal, a version number for the current synchronization of the file performed by the terminal, and a user identifier of the terminal that are sent by the terminal;

updating, according to the identification information of the terminal, the version number for the current synchronization of the file performed by the terminal, and the user identifier of the terminal, a record of synchronization performed by a user on the terminal;

querying for a version number of the file that is latest synchronized by another terminal of the user; and

if the version number for the current synchronization of the file performed by the terminal is earlier than the version number of the file that is latest synchronized by the another terminal of the user, deleting, from the data that is of the various versions of the file and stored in the server, an operation record generated before the file synchronization request is received.

According to a second aspect, the present application provides a file synchronization method, including:

sending a file synchronization request to a server;

searching for second record data, where the second record data includes an operation record performed on a file after a terminal latest synchronizes the file;

receiving first record data sent after the server responds to the file synchronization request, where the first record data includes an operation record generated, for the file of a predetermined version in data that is of various versions of the file and stored in the server, after the terminal latest synchronizes the file; and

obtaining, according to the first record data and the second record data, an operation that should be performed by the terminal, and performing the operation.

With reference to the second aspect, in a first possible implementation manner, the searching for second record data includes:

searching for each operation record performed on the file after the terminal latest synchronizes the file; and

dividing or combining each operation record according to an operation path to obtain the second record data.

With reference to the second aspect, in a second possible implementation manner, the first record data includes at least one operation record; and

the obtaining, according to the first record data and the second record data, an operation that should be performed by the terminal, and performing the operation includes:

dividing or combining the at least one operation record according to an operation path to simplify the first record data; and

obtaining, according to simplified first record data and the second record data, the operation that should be performed by the terminal, and performing the operation.

With reference to the second aspect, and the first and the second possible implementation manners of the second aspect, in a third possible implementation manner, after the obtaining, according to the first record data and the second record data, an operation that should be performed by the terminal, and performing the operation, the method further includes:

recording a latest version number of the file in the first record data as a version number for current synchronization of the file performed by the terminal; and

sending identification information of the terminal, the version number for the current synchronization of the file performed by the terminal, and a user identifier of the terminal to the server, so that the server updates a record of synchronization performed by a user on the terminal.

According to a third aspect, the present application provides a server, including:

a first receiving module, configured to receive a file synchronization request sent by a terminal;

a searching module, configured to respond to the file synchronization request, and search data that is of various versions of a file and stored in the server for first record data, where the first record data includes an operation record generated for the file of a predetermined version after the terminal latest synchronizes the file; and

a sending module, configured to send the first record data to the terminal, so that the terminal obtains, according to the first record data and second record data in the terminal, an operation that should be performed by the terminal, where the second record data includes an operation record performed on the file after the terminal latest synchronizes the file.

With reference to the third aspect, in a first possible implementation manner, the file synchronization request includes a version number of the file that is latest synchronized by the terminal and a latest version number for current synchronization; and

the first record data includes all operation records generated for the file of the predetermined version after the terminal latest synchronizes the file, where a version number of the predetermined version is later than the version number of the file that is latest synchronized by the terminal and is earlier than or equal to the latest version number for the current synchronization.

With reference to the third aspect, in a second possible implementation manner, the file synchronization request includes a version number of the file that is latest synchronized by the terminal and a quantity threshold; and

the first record data includes a predetermined quantity of operation records successively generated for the file of the predetermined version after the terminal latest synchronizes the file, where a version number of the predetermined version is later than the version number of the file that is latest synchronized by the terminal, and a value of the predetermined quantity is equal to the quantity threshold.

With reference to the third aspect, and the first and the second possible implementation manners of the third aspect, in a third possible implementation manner, the server further includes:

a second receiving module, configured to receive identification information of the terminal, a version number for the current synchronization of the file performed by the terminal, and a user identifier of the terminal that are sent by the terminal;

an updating module, configured to update, according to the identification information of the terminal, the version number for the current synchronization of the file performed by the terminal, and the user identifier of the terminal, a record of synchronization performed by a user on the terminal;

a querying module, configured to query for a version number of the file that is latest synchronized by another terminal of the user; and

a deleting module, configured to: if the version number for the current synchronization of the file performed by the terminal is earlier than the version number of the file that is latest synchronized by the another terminal of the user, delete, from the data that is of the various versions of the file and stored in the server, an operation record generated before the file synchronization request is received.

According to a fourth aspect, the present application provides a computer storage medium, where the computer storage medium stores a program, and the program performs all or some of the steps of the file synchronization method provided in the first aspect of the present application.

According to a fifth aspect, the present application provides a server, including: an input apparatus, an output apparatus, and a processor, where the input apparatus, the output apparatus, and the processor are connected through a bus, where:

the input apparatus is configured to receive a file synchronization request sent by a terminal;

the processor responds to the file synchronization request, and searches data that is of various versions of a file and stored in the server for first record data, where the first record data includes an operation record generated for the file of a predetermined version after the terminal latest synchronizes the file; and

the output apparatus is configured to send the first record data to the terminal, so that the terminal obtains, according to the first record data and second record data in the terminal, an operation that should be performed by the terminal, where the second record data includes an operation record performed on the file after the terminal latest synchronizes the file.

With reference to the fifth aspect, in a first possible implementation manner, the file synchronization request includes a version number of the file that is latest synchronized by the terminal and a latest version number for current synchronization; and

the first record data includes all operation records generated for the file of the predetermined version after the terminal latest synchronizes the file, where a version number of the predetermined version is later than the version number of the file that is latest synchronized by the terminal and is earlier than or equal to the latest version number for the current synchronization.

With reference to the fifth aspect, in a second possible implementation manner, the file synchronization request includes a version number of the file that is latest synchronized by the terminal and a quantity threshold; and

the first record data includes a predetermined quantity of operation records successively generated for the file of the predetermined version after the terminal latest synchronizes the file, where a version number of the predetermined version is later than the version number of the file that is latest synchronized by the terminal, and a value of the predetermined quantity is equal to the quantity threshold.

With reference to the fifth aspect, and the first and the second possible implementation manners of the fifth aspect, in a third possible implementation manner, the input apparatus is further configured to receive identification information of the terminal, a version number for the current synchronization of the file performed by the terminal, and a user identifier of the terminal that are sent by the terminal; and

the processor is further configured to:

update, according to the identification information of the terminal, the version number for the current synchronization of the file performed by the terminal, and the user identifier of the terminal, a record of synchronization performed by a user on the terminal;

query for a version number of the file that is latest synchronized by another terminal of the user; and

if the version number for the current synchronization of the file performed by the terminal is earlier than the version number of the file that is latest synchronized by the another terminal of the user, delete, from the data that is of the various versions of the file and stored in the server, an operation record generated before the file synchronization request is received.

According to a sixth aspect, the present application provides a terminal, including:

a first sending module, configured to send a file synchronization request to a server;

a searching module, configured to search for second record data, where the second record data includes an operation record performed on a file after the terminal latest synchronizes the file;

a receiving module, configured to receive first record data sent after the server responds to the file synchronization request, where the first record data includes an operation record generated, for the file of a predetermined version in data that is of various versions of the file and stored in the server, after the terminal latest synchronizes the file; and

an execution module, configured to obtain, according to the first record data and the second record data, an operation that should be performed by the terminal, and perform the operation.

With reference to the sixth aspect, in a first possible implementation manner, the searching module includes:

a searching unit, configured to search for each operation record performed on the file after the terminal latest synchronizes the file; and

a first simplifying unit, configured to divide or combine each operation record according to an operation path to obtain the second record data.

With reference to the sixth aspect, in a second possible implementation manner, the first record data includes at least one operation record; and

the execution module includes:

a second simplifying unit, configured to divide or combine the at least one operation record according to an operation path to simplify the first record data; and

an execution unit, configured to obtain, according to simplified first record data and the second record data, an operation that should be performed by the terminal, and perform the operation.

With reference to the sixth aspect, and the first and the second possible implementation manners of the sixth aspect, in a third possible implementation manner, the terminal further includes:

a recording module, configured to record a latest version number of the file in the first record data as a version number for current synchronization of the file performed by the terminal; and

a second sending module, configured to send identification information of the terminal, the version number for the current synchronization of the file performed by the terminal, and a user identifier of the terminal to the server, so that the server updates a record of synchronization performed by a user on the terminal.

According to a seventh aspect, the present application provides a computer storage medium, where the computer storage medium stores a program, and the program performs all or some of the steps of the file synchronization method provided in the second aspect of the present application.

According to an eighth aspect, the present application provides a terminal, including: an input apparatus, an output apparatus, and a processor, where the input apparatus, the output apparatus, and the processor are connected through a bus, where:

the output apparatus is configured to send a file synchronization request to a server;

the input apparatus is configured to receive first record data sent after the server responds to the file synchronization request, where the first record data includes an operation record generated, for a file of a predetermined version in data that is of various versions of the file and stored in the server, after the terminal latest synchronizes the file; and

the processor is configured to:

search for second record data, where the second record data includes an operation record performed on the file after the terminal latest synchronizes the file; and

obtain, according to the first record data and the second record data, an operation that should be performed by the terminal, and perform the operation.

With reference to the eighth aspect, in a first possible implementation manner, when the processor searches for the second record data, specific steps are as follows:

searching for each operation record performed on the file after the terminal latest synchronizes the file; and

dividing or combining each operation record according to an operation path to obtain the second record data.

With reference to the eighth aspect, in a second possible implementation manner, the first record data includes at least one operation record; and

when the processor obtains, according to the first record data and the second record data, the operation that should be performed by the terminal, and performs the operation, specific steps are as follows:

dividing or combining the at least one operation record according to an operation path to simplify the first record data; and

obtaining, according to simplified first record data and the second record data, the operation that should be performed by the terminal, and performing the operation.

With reference to the eighth aspect, and the first and the second possible implementation manners of the eighth aspect, in a third possible implementation manner,

the processor is further configured to record a latest version number of the file in the first record data as a version number for current synchronization of the file performed by the terminal; and

the output apparatus is further configured to send identification information of the terminal, the version number for the current synchronization of the file performed by the terminal, and a user identifier of the terminal to the server, so that the server updates a record of synchronization performed by a user on the terminal.

In the present application, after receiving a file synchronization request sent by a terminal, a server searches stored data of various versions of a file for an operation record generated for the file after the terminal previously synchronizes the file and sends the operation record to the terminal, without a need for performing multiple interactions with the terminal. In addition, compared with an entire directory structure of the file, a data volume of the operation record of the file is relatively small, which can not only reduce a transmission time but also reduce consumption of a network resource of a user. The terminal may determine, with reference to an operation record sent by the server and an operation record performed on the file after the terminal previously synchronizes the file, an operation that should be performed, without a need for traversing a file directory in the server layer by layer or comparing the file directory in the server with a file directory in the terminal. In this way, a synchronization time can be effectively reduced, and synchronization efficiency can be improved.

### BRIEF DESCRIPTION OF DRAWINGS

To describe the technical solutions in the present application more clearly, the following briefly introduces the accompanying drawings required in embodiments. Apparently, the accompanying drawings in the following description show merely some embodiments of the present application, and a person of ordinary skill in the art may still derive other drawings from these accompanying drawings without creative efforts.

FIG. 1 is a schematic flowchart of an embodiment of a file synchronization method according to the present application;

FIG. 2 is a schematic flowchart of another embodiment of a file synchronization method according to the present application;

FIG. 3 is a schematic flowchart of still another embodiment of a file synchronization method according to the present application;

FIG. 4 is a schematic diagram of a structure of an embodiment of a server according to the present application;

FIG. 5 is a schematic diagram of a structure of another embodiment of a server according to the present application;

FIG. 6 is a schematic diagram of a structure of still another embodiment of a server according to the present application;

FIG. 7 is a schematic diagram of a structure of an embodiment of a terminal according to the present application;

FIG. 8 is a schematic diagram of a structure of another embodiment of a terminal according to the present application; and

FIG. 9 is a schematic diagram of a structure of still another embodiment of a terminal according to the present application.

### DESCRIPTION OF EMBODIMENTS

The following clearly and completely describes the technical solutions in the embodiments of the present application with reference to the accompanying drawings in the embodiments of the present application. Apparently, the described embodiments are merely some but not all of the embodiments of the present application. All other embodiments obtained by a person of ordinary skill in the art based on the embodiments of the present application without creative efforts shall fall within the protection scope of the present application.

The present application provides a file synchronization method, a server, and a terminal, which can shorten a synchronization time, improve synchronization efficiency, and reduce consumption of a network resource. Details are separately illustrated in the following with reference to the accompanying drawings.

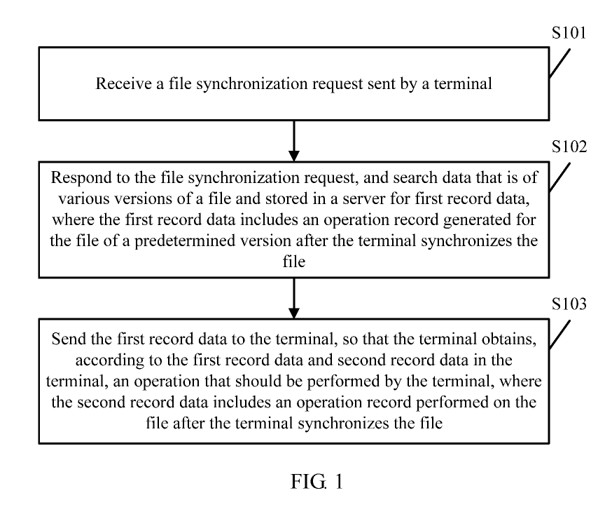

Referring to FIG. 1, FIG. 1 is a schematic flowchart of an embodiment of a file synchronization method according to the present application. The file synchronization method shown in FIG. 1 may be specifically implemented by a server. As shown in FIG. 1, the file synchronization method may include the following steps:

Step S101: Receive a file synchronization request sent by a terminal.

In the present application, the server receives the file synchronization request sent by the terminal, where the file synchronization request may indicate a file that needs to be currently synchronized by the terminal, a time at which the terminal latest synchronizes the file, a version number of the file that is latest synchronized by the terminal, and/or data (including a directory structure and/or an operation record, and the like) that needs to be provided by the server when the terminal currently synchronizes the file.

Step S102: Respond to the file synchronization request, and search data that is of various versions of a file and stored in the server for first record data, where the first record data includes an operation record generated for the file of a predetermined version after the terminal latest synchronizes the file.

In specific implementation, the first record data is an operation record, in data that is of various versions of the file and sent by another terminal or a data management application to the server, which is generated for the file of the predetermined version due to various modification operations such as insertion, addition, deletion, and the like after the terminal completes the latest synchronization of the file. Specifically, the foregoing predetermined version is determined by the file synchronization request sent by the terminal.

In a possible implementation manner, the file synchronization request may include a version number of the file that is latest synchronized by the terminal and a latest version number for current synchronization. In this case, the first record data includes all operation records generated for the file of the predetermined version after the terminal latest synchronizes the file, where the predetermined version is all versions whose version numbers are from the version number of the file that is latest synchronized by the terminal to the latest version number for the current synchronization (including the latest version number for the current synchronization). Specifically, the latest version number for the current synchronization may be the latest version number of the current file, or may be any version number that is later than a version number of the latest synchronization, which may specifically depend on a current network status of the terminal. For example, when a network resource of the terminal is sufficient (for example, in a state of a broadband network connection or a wireless network connection), the latest version number for the current synchronization may be the latest version number of the current file; when the terminal is short of a network resource (for example, in a state of a mobile network connection), the latest version number for the current synchronization may be later than the version number of the file that is latest synchronized by the terminal and earlier than the latest version number of the current file. For example, if the version number of the file that is latest synchronized by the terminal is V1.0, a time is 2014-02-25 9:00:00, the latest version number of the file so far is V9.0, but the terminal is in the state of the mobile network connection, and remaining traffic is not much, then the latest version number for the current synchronization may be V4.0, the foregoing predetermined version is from V2.0 to V4.0, and the first record data includes an operation record generated for the file of a version from V2.0 to V4.0 after 2014-02-25 9:00:00.

In a possible implementation manner, the file synchronization request may include a version number of the file that is latest synchronized by the terminal and a quantity threshold. In this case, the first record data may include a predetermined quantity of operation records successively generated for the file of the predetermined version after the terminal completes the latest synchronization of the file, where a version number of the predetermined version is later than the version number of the file that is latest synchronized by the terminal, and a value of the predetermined quantity is equal to the quantity threshold. In specific implementation, file data whose version number is later than the version number of the file that is latest synchronized by the terminal may be first found from the data that is of the various versions of the file and stored in the server; then starting from a time point at which the terminal completes the latest synchronization of the file, the predetermined quantity (the value of the predetermined quantity is equal to the quantity threshold in the file synchronization request) of operation records are sorted out, in ascending order of operation time, from the found file data, and are used as the first record data.

Step S103: Send the first record data to the terminal, so that the terminal obtains, according to the first record data and second record data in the terminal, an operation that should be performed by the terminal, where the second record data includes an operation record performed on the file after the terminal latest synchronizes the file.

In specific implementation, the first record data found in step S102 includes at least one operation record.

In a possible implementation manner, if a network resource in an environment in which the terminal is located is sufficient, the server may directly send the at least one found operation record to the terminal, so as to alleviate computing pressure on the server.

In another possible implementation manner, if the terminal is located in a mobile network environment or a congested network channel, before the first record data is sent to the terminal, the at least one operation record may be first divided or combined according to an operation path. For example, “MOVE A, f1 to f2” may be divided into “DELETE A, f1” and “ADD A, f2”, and “ADD B, f1”, “ADD C, f1”, and “DELETE B, f1” may be combined into “ADD C, f1”.

For dividing the at least one operation record, the at least one operation record may be converted into basic operation records of ADD or DELETE that involve only one path. Redundant data may be removed by combining, according to the operation path, these basic operation records obtained after division, so as to intuitively present a final change of the file caused by the first record data. In this way, consumption of a network resource and a data transmission time can be reduced.

In some possible implementation manners, after the first record data is sent to the terminal, the file synchronization method may further include:

receiving identification information of the terminal, a version number for the current synchronization of the file performed by the terminal, and a user identifier of the terminal that are sent by the terminal;

updating, according to the identification information of the terminal, the version number for the current synchronization of the file performed by the terminal, and the user identifier of the terminal, a record of synchronization performed by a user on the terminal;

querying for a version number of the file that is latest synchronized by another terminal of the user; and

if the version number for the current synchronization of the file performed by the terminal is earlier than the version number of the file that is latest synchronized by the another terminal of the user, deleting, from the data that is of the various versions of the file and stored in the server, an operation record generated before the file synchronization request is received.

In specific implementation, the record of synchronization performed by the user on the terminal may include the identification information of the terminal, the user identifier of the terminal, a time of and a version number for synchronizing the file, and the like.

In specific implementation, after the synchronization is completed, if a version stored by the terminal is an earliest version of the file, an operation record that is generated, for the file stored in the server, before a time point at which the current synchronization starts may be deleted, so as to reduce redundant storage on the server and alleviate storage pressure on the server.

In the file synchronization method described in FIG. 1, after receiving a file synchronization request sent by a terminal, a server searches stored data of various versions of a file for an operation record generated for the file after the terminal previously synchronizes the file, and sends the operation record to the terminal, without a need for performing multiple interactions with the terminal. In addition, compared with an entire directory structure of the file, a data volume of the operation record of the file is relatively small, which not only reduces a transmission time but also can reduce consumption of a network resource of a user. The terminal may determine, with reference to the operation record sent by the server and an operation record performed on the file after the terminal previously synchronizes the file, an operation that should be performed, without a need for traversing a file directory in the server layer by layer or comparing the file directory in the server with a file directory in the terminal. In this way, a synchronization time can be effectively reduced, and synchronization efficiency can be improved.

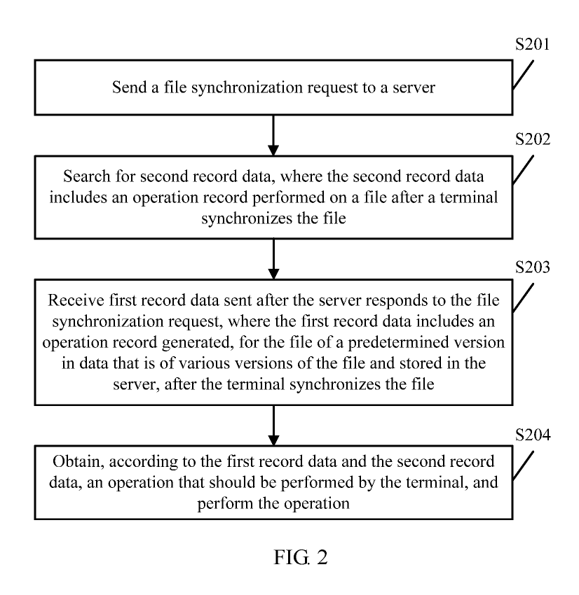

Referring to FIG. 2, FIG. 2 is a schematic flowchart of another embodiment a file synchronization method according to the present application. The file synchronization method shown in FIG. 2 may be specifically implemented by a terminal. As shown in FIG. 2, the file synchronization method may include the following steps:

S201. Send a file synchronization request to a server.

In the present application, the terminal sends the file synchronization request to the server, where the file synchronization request may indicate a file that needs to be currently synchronized by the terminal, a time at which the terminal latest synchronizes the file, a version number of the file that is latest synchronized by the terminal, and/or data (including a directory structure and/or an operation record and the like) that needs to be provided by the server when the file is currently synchronized.

S202. Search for second record data, where the second record data includes an operation record performed on the file after the terminal latest synchronizes the file.

In the present application, the terminal may include two types: One type is a terminal that can directly acquire an operation record of the file, where the terminal of this type generally includes an input apparatus and a processor and can independently perform an operation on a file, for example, a computer and a tablet computer; the other one is a terminal that cannot directly acquire an operation record of a file, for example, a USB flash drive for synchronization.

Based on different types of terminals, correspondingly, the terminal may also search for the second record data in different implementation manners.

In a possible implementation manner, when the terminal can directly acquire the operation record of the file, the step of searching for second record data may include: first, searching for each operation record performed on the file after the terminal latest completes synchronization of the file; and then, dividing or combining these operation records according to an operation path to obtain the second record data.

Specifically, the dividing refers to dividing an operation record that involves multiple paths into multiple basic operation records that involve only one path. For example, “MOVE A, f1 to f2” may be divided into “DELETE A, f1” and “ADD A, f2”. The combining refers to combining multiple operation records that have a same operation path into a relatively small quantity of operation records. For example, “ADD B, f1”, “ADD C, f1”, and “DELETE B, f1” may be combined into “ADD C, f1”. The division and combination operations can simplify data required during synchronization and remove redundant data, so as to shorten a synchronization time and improve synchronization efficiency.

In another possible implementation manner, when the terminal cannot directly acquire the operation record of the file, the step of searching for second record data may include: first, reading directory information of the file that is obtained and stored after the terminal latest completes synchronization of the file; then, comparing the directory information of the file that is obtained after the terminal latest completes synchronization of the file with directory information of the file that is currently and locally stored in the terminal, so that the operation record that is performed on the file after the terminal latest completes synchronization of the file can be obtained, where the operation record includes added data and/or deleted data, and the like, and the operation record is the second record data.

S203. Receive first record data sent after the server responds to the file synchronization request, where the first record data includes an operation record generated, for the file of a predetermined version in data that is of various versions of the file and stored in the server, after the terminal latest synchronizes the file.

In specific implementation, based on different content of the file synchronization request, correspondingly, the first record data may also have several different cases.

In a possible implementation manner, the file synchronization request may include a version number of the file that is latest synchronized by the terminal and a latest version number for the current synchronization. In this case, the first record data includes all operation records generated for the file of the predetermined version after the terminal latest synchronizes the file, where the predetermined version is all versions whose version numbers are from the version number of the file that is latest synchronized by the terminal to the latest version number for the current synchronization (including the latest version number for the current synchronization). Specifically, the latest version number for the current synchronization may be the latest version number of the current file, or may be any version number that is later than the version number of the latest synchronization, which may specifically depend on a current network status of the terminal.

In a possible implementation manner, the file synchronization request may include the version number of the file that is latest synchronized by the terminal and a quantity threshold. In this case, the first record data may include a predetermined quantity of operation records successively generated for the file of the predetermined version after the terminal latest completes synchronization of the file, where a version number of the predetermined version is later than the version number of the file that is latest synchronized by the terminal, and a value of the predetermined quantity is equal to the quantity threshold.

S204. Obtain, according to the first record data and the second record data, an operation that should be performed by the terminal, and perform the operation.

In specific implementation, the operation that should be performed by the terminal in the current synchronization may be obtained by means of computing and with reference to the operation record generated, after a time point at which the terminal latest completes synchronization of the file, by the file that is of the predetermined version and stored in the server, and the operation record performed on the file by the terminal, for example, data that needs to be added, and data that needs to be deleted.

In a possible implementation manner, the first record data sent by the server is multiple operation records that are directly found from data of various versions of the file by the server and have not undergone simplifying processing. In this case, the obtaining, according to the first record data and the second record data, an operation that should be performed by the terminal may include the following steps:

First, divide or combine the multiple operation records according to an operation path to simplify the first record data. Specifically, the dividing refers to dividing an operation record that involves multiple paths into multiple basic operation records that involve only one path, and the combining refers to combining multiple operation records that have a same operation path into a relatively small quantity of operation records. For example, “MOVE A, f1 to f2” may be divided into “DELETE A, f1” and “ADD A, f2”, and “ADD B, f1”, “ADD C, f1”, and “DELETE B, f1” may be combined into “ADD C, f1”. The division and combination operations can simplify data required during synchronization and remove redundant data, so as to shorten a synchronization time and improve synchronization efficiency.

Then, obtain, according to simplified first record data and the second record data, the operation that should be performed by the terminal, and perform the operation. In this case, if operation records in both the first record data and the second record data are basic operation records that involve only one operation path, the obtaining, according to the first record data and the second record data, an operation that should be performed by the terminal may be specifically: using the time point at which the terminal previously completes synchronization of the file as a start point; combining, in ascending order of operation time, operation records that are in the first record data and the second record data and have a same operation path; and obtaining, according to a combined operation record, the operation that should be performed by the terminal. For example, operation records whose operation paths are disk 1 (f1) are “ADD A, f1”, “ADD B, f1”, “ADD C, f1”, and “DELETE B, f1”, and the foregoing four operation records may be combined into “ADD AB, f1”; then, the operation that should be performed by the terminal is adding “AB” to the disk 1.

In a possible implementation manner, after the obtaining an operation that should be performed by the terminal, and performing the operation, the file synchronization method may further include:

recording a latest version number of the file in the first record data as a version number for current synchronization of the file performed by the terminal; and sending identification information of the terminal, the version number for the current synchronization of the file performed by the terminal, and a user identifier of the terminal to the server, so that the server updates a record of synchronization performed by a user on the terminal.

In specific implementation, the record of synchronization performed by the user on the terminal may include the identification information of the terminal, the user identifier of the terminal, a time and version number of synchronizing the file, and the like.

In the file synchronization method described in FIG. 2, a terminal sends a file synchronization request to a server, searches for second record data, and receives first record data sent by the server, without a need for performing multiple interactions with the server and without a need for traversing a file directory in the server layer by layer. In addition, the first record data includes an operation record generated by a file after the terminal previously synchronizes the file. Compared with an entire directory structure of the file, a data volume is relatively small, which not only reduces a transmission time but also can reduce consumption of a network resource of a user. The second record data is an operation record performed on the file after the terminal previously completes synchronization of the file. The terminal can obtain, by dividing and combining the first record data and with reference to the second record data, an operation that should be performed by the terminal, which can not only reduce redundant data and a computing volume required during synchronization but also alleviate computing pressure on the terminal and improve synchronization efficiency.

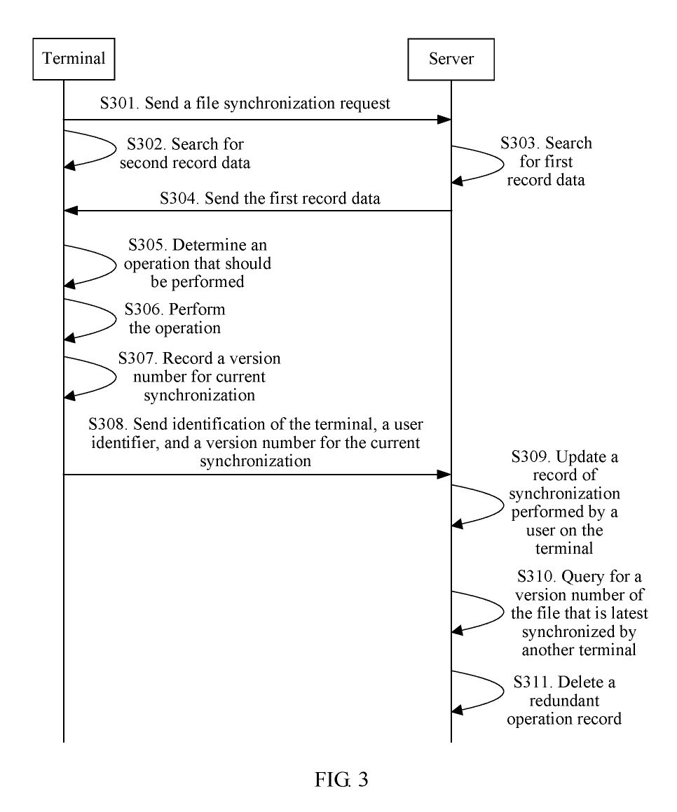

Referring to FIG. 3, FIG. 3 is a schematic flowchart of still another embodiment of a file synchronization method according to the present application. The file synchronization method shown in FIG. 3 may be specifically implemented by an interaction between a server and a terminal. As shown in FIG. 3, the file synchronization method may include the following steps:

S301. The terminal sends a file synchronization request to the server.

In the present application, the terminal sends the file synchronization request to the server, where the file synchronization request may indicate a file that needs to be currently synchronized by the terminal, a time at which the terminal latest synchronizes the file, a version number of the file that is latest synchronized by the terminal, and/or data (including a directory structure and/or an operation record and the like) that needs to be provided by the server when the file is currently synchronized.

S302. The terminal searches for second record data.

In the present application, the second record data includes an operation record performed on the file after the terminal previously completes synchronization of the file. The terminal may include two types: One type is a terminal that can directly acquire an operation record of a file, where the terminal of this type generally includes an input apparatus and a processor and can independently perform an operation on a file, for example, a computer and a tablet computer; the other one is a terminal that cannot directly acquire an operation record of a file, for example, a USB flash drive for synchronization.

Based on different types of terminals, correspondingly, the terminal may also search for the second record data in different implementation manners.

In a possible implementation manner, when the terminal can directly acquire the operation record of the file, the step of searching for second record data may include: first, searching for each operation record performed on the file after the terminal latest completes synchronization of the file; then, dividing or combining these operation records according to an operation path to obtain the second record data.

In another possible implementation manner, when the terminal cannot directly acquire the operation record of the file, the step of searching for second record data may include: first, reading directory information of the file that is obtained and stored after the terminal latest completes synchronization of the file; then, comparing the directory information of the file that is obtained after the terminal latest completes synchronization of the file with directory information of the file that is currently and locally stored in the terminal, so that the operation record that is performed on the file after the terminal latest completes synchronization of the file can be obtained, where the operation record includes added data and/or deleted data, and the like, and the operation record is the second record data.

Step S303: The server searches for first record data.

In specific implementation, the first record data is an operation record, in data that is of various versions of the file and sent by another terminal or a data management application to the server, which is generated for the file of the predetermined version due to various modification operations such as insertion, addition, deletion, and the like after the terminal completes the latest synchronization of the file. Specifically, the foregoing predetermined version is determined by the file synchronization request sent by the terminal.

In a possible implementation manner, the file synchronization request may include a version number of the file that is latest synchronized by the terminal and a latest version number for current synchronization. In this case, the first record data includes all operation records generated for the file of the predetermined version after the terminal latest synchronizes the file, where the predetermined version is all versions whose version numbers are from the version number of the file that is latest synchronized by the terminal to the latest version number for the current synchronization (including the latest version number for the current synchronization). Specifically, the latest version number for the current synchronization may be the latest version number of the current file, or may be any version number that is later than the version number of the latest synchronization, which may specifically depend on a current network status of the terminal.

In a possible implementation manner, the file synchronization request may include a version number of the file that is latest synchronized by the terminal and a quantity threshold. In this case, the first record data may include a predetermined quantity of operation records successively generated for the file of the predetermined version after the terminal completes the latest synchronization of the file, where a version number of the predetermined version is later than the version number of the file that is latest synchronized by the terminal, and a value of the predetermined quantity is equal to the quantity threshold. In specific implementation, file data whose version number is later than the version number of the file that is latest synchronized by the terminal may be first found from the data that is of the various versions of the file and stored in the server; then starting from a time point at which the terminal completes the latest synchronization of the file, the predetermined quantity (the value of the predetermined quantity is equal to the quantity threshold in the file synchronization request) of operation records are sorted out, in ascending order of operation time, from the found file data, and are used as the first record data.

Step S304: The server sends the first record data to the terminal.

In specific implementation, the first record data includes at least one operation record. In a possible implementation manner, if a network resource in an environment in which the terminal is located is sufficient, the server may directly send at least one found operation record to the terminal, so as to alleviate computing pressure on the server.

In another possible implementation manner, if the terminal is located in a mobile network environment or a congested network channel, before the first record data is sent to the terminal, the at least one operation record may be first divided or combined according to an operation path.

Step S305: The terminal determines an operation that should be performed.

In specific implementation, the terminal can obtain, by means of computing and with reference to the first record data and the second record data, the operation that should be performed in the current synchronization, for example, data that needs to be added, and data that needs to be deleted.

In a possible implementation manner, the first record data is multiple operation records that are found directly from data of various versions of the file by the server and have not undergone simplifying processing. In this case, the obtaining, according to the first record data and the second record data, the operation that should be performed by the terminal may include the following steps:

First, divide or combine the multiple operation records according to an operation path to simplify the first record data. Specifically, the dividing refers to dividing an operation record that involves multiple paths into multiple basic operation records that involve only one path, and the combining refers to combining multiple operation records that have a same operation path into a relatively small quantity of operation records.

Then, obtain, according to simplified first record data and the second record data, the operation that should be performed by the terminal, and perform the operation. In this case, if operation records in both the first record data and the second record data are basic operation records that involve only one operation path, the obtaining, according to the first record data and the second record data, an operation that should be performed by the terminal may be specifically: using the time point at which the terminal previously completes synchronization of the file as a start point; combining, in ascending order of operation time, operation records that are in the first record data and the second record data and have a same operation path; and obtaining, according to a combined operation record, the operation that should be performed by the terminal.

Step S306: The terminal performs the foregoing operation that should be performed.

Step S307: The terminal records a version number of the file for current synchronization, that is specifically, records a latest version number of the file in the first record data as a version number for the current synchronization of the file performed by the terminal.

Step S308: The terminal sends identification information of the terminal, the version number for the current synchronization of the file performed by the terminal, and a user identifier of the terminal to the server.

Step S309: The server updates, according to the identification information of the terminal, the version number for the current synchronization of the file performed by the terminal, and the user identifier of the terminal, a record of synchronization performed by a user on the terminal. In specific implementation, the record of synchronization performed by the user on the terminal may include the identification information of the terminal, the user identifier of the terminal, a synchronization time, a version number of the synchronization, and the like.

Step S310: The server queries for a version number of the file that is latest synchronized by another terminal of the user.

Step S311: The server deletes a redundant operation record. Specifically, if the version number for the current synchronization of the file performed by the terminal is earlier than the version number of the file that is latest synchronized by the another terminal of the user, an operation record generated before the file synchronization request is received is deleted from the data that is of the various versions of the file and stored in the server, so as to reduce redundant storage on the server and alleviate storage pressure on the server.

In the file synchronization method described in FIG. 3, a server does not need to perform multiple interactions with a terminal and does not need to traverse a file directory in the server layer by layer, which can reduce a time consumed for synchronization; the terminal simplifies and then synchronizes an operation record, so as to reduce redundant data, further shorten the time consumed for synchronization, and improve synchronization efficiency.

Correspondingly, the present application further provides apparatus embodiments of a server and a terminal that may be configured to implement the method embodiments of the present application. The following uses examples to describe a structural composition of the server and the terminal in the present application with reference to the accompanying drawings.

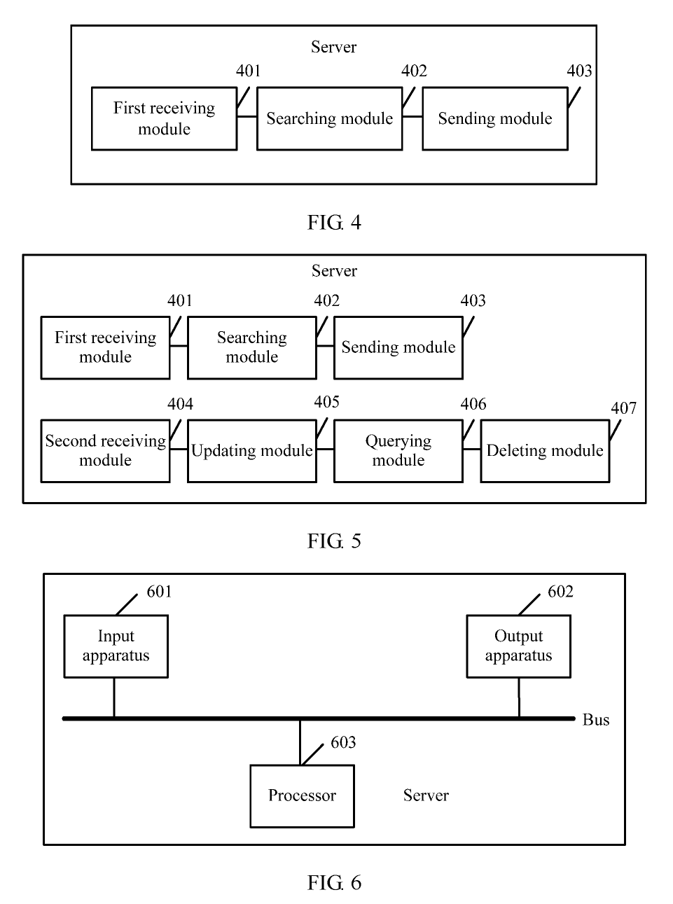

Referring to FIG. 4, FIG. 4 is a schematic diagram of a structure of an embodiment of a server according to the present application. As shown in FIG. 4, the server may include: a first receiving module 401, a searching module 402, and a sending module 403. In some possible implementation manners, the server may further include at least one of: a second receiving module 404, an updating module 405, a querying module 406, and a deleting module 407.

The first receiving module 401 is configured to receive a file synchronization request sent by a terminal.

The searching module 402 is configured to respond to the file synchronization request, and search data that is of various versions of a file and stored in the server for first record data, where the first record data includes an operation record generated for the file of a predetermined version after the terminal latest synchronizes the file.

The sending module 403 is configured to send the first record data to the terminal, so that the terminal obtains, according to the first record data and second record data in the terminal, an operation that should be performed by the terminal, where the second record data includes an operation record performed on the file after the terminal latest synchronizes the file.

In the present application, the server receives the file synchronization request sent by the terminal, where the file synchronization request may indicate a file that needs to be currently synchronized by the terminal, a time at which the terminal latest synchronizes the file, a version number of the file that is latest synchronized by the terminal, and/or data (including a directory structure and/or an operation record, and the like) that needs to be provided by the server when the terminal currently synchronizes the file.

In specific implementation, the first record data is an operation record generated after the terminal latest completes synchronization of the file, due to various modifying operations such as inserting, adding, and deleting, and by the file of the predetermined version in data that is of various versions of the file and sent by another terminal or a data management application to the server. Specifically, the foregoing predetermined version is determined by the file synchronization request sent by the terminal.

In a possible implementation manner, the file synchronization request may include a version number of the file that is latest synchronized by the terminal and a latest version number for current synchronization. In this case, the first record data includes all operation records generated for the file of the predetermined version after the terminal latest synchronizes the file, where the predetermined version is all versions whose version numbers are from the version number of the file that is latest synchronized by the terminal to the latest version number for the current synchronization (including the latest version number for the current synchronization). Specifically, the latest version number for the current synchronization may be the latest version number of the current file, or may be any version number that is later than a version number of latest synchronization, which may specifically depend on a current network status of the terminal. For example, when a network resource of the terminal is sufficient (for example, in a state of a broadband network connection or a wireless network connection), the latest version number for the current synchronization may be the latest version number of the current file; when a network resource of the terminal is insufficient (for example, in a state of a mobile network connection), the latest version number for the current synchronization may be later than the version number of the file that is latest synchronized by the terminal and earlier than the latest version number of the current file.

In a possible implementation manner, the file synchronization request may include the version number of the file that is latest synchronized by the terminal and a quantity threshold. In this case, the first record data may include a predetermined quantity of operation records successively generated for the file of the predetermined version after the terminal latest completes synchronization of the file, where a version number of the predetermined version is later than the version number of the file that is latest synchronized by the terminal, and a value of the predetermined quantity is equal to the quantity threshold. In specific implementation, the searching module 402 may first find file data whose version number is later than the version number of the file that is latest synchronized by the terminal from the data that is of the various versions of the file and stored in the server; then use a time point at which the terminal latest completes synchronization of the file is used as a start point; and sort out, in ascending order of operation time, the predetermined quantity (the value of the predetermined quantity is equal to the quantity threshold in the file synchronization request) of operation records from the found file data, and use the predetermined quantity of the operation records as the first record data.

In specific implementation, the first record data found by the searching module 402 includes at least one operation record.

In a possible implementation manner, if a network resource in an environment in which the terminal is located is sufficient, the sending module 403 may directly send at least one found operation record to the terminal, so as to alleviate computing pressure on the server.

In another possible implementation manner, if the terminal is located in a mobile network environment or a congested network channel, before the sending module 403 sends the first record data to the terminal, the at least one operation record may be first divided or combined according to an operation path. For example, “MOVE A, f1 to f2” may be divided into “DELETE A, f1” and “ADD A, f2”, and “ADD B, f1”, “ADD C, f1”, and “DELETE B, f1” may be combined into “ADD C, f1”.

The at least one operation record may be converted, by dividing the at least one operation record, into basic operation records of ADD or DELETE that involve only one path. Redundant data may be removed by combining, according to the operation path, these basic operation records obtained after the dividing, so as to visually present a final change of the file caused by the first record data. In this way, consumption of a network resource and a data transmission time can be reduced.

In a possible implementation manner, as shown in FIG. 5, the server may further include at least one of: the second receiving module 404, the updating module 405, the querying module 406, and the deleting module 407.

The second receiving module 404 is configured to receive identification information of the terminal, a version number for the current synchronization of the file performed by the terminal, and a user identifier of the terminal that are sent by the terminal.

The updating module 405 is configured to update, according to the identification information of the terminal, the version number for the current synchronization of the file performed by the terminal, and the user identifier of the terminal, a record of synchronization performed by a user on the terminal.

The querying module 406 is configured to query for a version number of the file that is latest synchronized by another terminal of the user.

The deleting module 407 is configured to: if the version number for the current synchronization of the file performed by the terminal is earlier than the version number of the file that is latest synchronized by the another terminal of the user, delete, from the data that is of the various versions of the file and stored in the server, an operation record generated before the file synchronization request is received.

In specific implementation, the record of synchronization performed by the user on the terminal may include the identification information of the terminal, the user identifier of the terminal, a time and version number of synchronizing the file, and the like.

In specific implementation, after the synchronization is completed, if a version stored by the terminal is an earliest version of the file, an operation record that is generated, for the file stored in the server, before a time point at which the current synchronization starts may be deleted, so as to reduce redundant storage on the server and alleviate storage pressure on the server.

In the server described in FIG. 4 or FIG. 5, after a first receiving module receives a file synchronization request sent by a terminal, a searching module searches data that is of various versions of a file and stored in the server for an operation record generated for the file after the terminal previously synchronizes the file. A sending module sends the operation record to the terminal, so that the server does not need to perform multiple interactions with the terminal. In addition, compared with an entire directory structure of the file, a data volume of the operation record is relatively small, which can not only reduce a transmission time but also reduce consumption of a network resource of a user. The terminal can obtain, with reference to the operation record sent by the server and an operation record performed on the file after the terminal previously synchronizes the file, an operation that should be performed, without a need for traversing a file directory in the server layer by layer or comparing the file directory in the server with a file directory in the terminal. In this way, a synchronization time can be effectively reduced, and synchronization efficiency can be improved.

Referring to FIG. 6, FIG. 6 is a schematic diagram of a structure of still another embodiment of a server according to the present application. As shown in FIG. 6, the server may include: an input apparatus 601, an output apparatus 602, and a processor 603. In some embodiments of the present application, the input apparatus 601 and the processor 603, and the output apparatus 602 and the processor 603 may be connected through a bus or another means, and a connection through a bus is used as an example in FIG. 6.

The input apparatus 601 is configured to receive a file synchronization request sent by a terminal.

The processor 603 is configured to respond to the file synchronization request, and search data that is of various versions of a file and stored in the server for first record data, where the first record data includes an operation record generated for the file of a predetermined version after the terminal latest synchronizes the file.

The output apparatus 602 is configured to send the first record data to the terminal, so that the terminal obtains, according to the first record data and second record data in the terminal, an operation that should be performed by the terminal, where the second record data includes an operation record performed on the file after the terminal latest synchronizes the file.

In a possible implementation manner, the file synchronization request includes a version number of the file that is latest synchronized by the terminal and a latest version number for current synchronization. In this case, the first record data includes all operation records generated for the file of the predetermined version after the terminal latest synchronizes the file, where a version number of the predetermined version is later than the version number of the file that is latest synchronized by the terminal and is earlier than or equal to the latest version number for the current synchronization.

In a possible implementation manner, the file synchronization request includes a version number of the file that is latest synchronized by the terminal and a quantity threshold. In this case, the first record data includes a predetermined quantity of operation records successively generated for the file of the predetermined version after the terminal latest synchronizes the file, where a version number of the predetermined version is later than the version number of the file that is latest synchronized by the terminal, and a value of the predetermined quantity is equal to the quantity threshold.

In a possible implementation manner, the first record data includes at least one operation record. In this case, before the output apparatus 602 sends the first record data to the terminal, the at least one operation record may be first divided or combined according to an operation path and then is sent to the terminal.

In a possible implementation manner, the input apparatus 601 is further configured to receive identification information of the terminal, a version number for the current synchronization of the file performed by the terminal, and a user identifier of the terminal that are sent by the terminal.

The processor 603 is further configured to:

update, according to the identification information of the terminal, the version number for the current synchronization of the file performed by the terminal, and the user identifier of the terminal, a record of synchronization performed by a user on the terminal;

query for a version number of the file that is latest synchronized by another terminal of the user; and

if the version number for the current synchronization of the file performed by the terminal is earlier than the version number of the file that is latest synchronized by the another terminal of the user, delete, from the data that is of the various versions of the file and stored in the server, an operation record generated before the file synchronization request is received.

In the server described in FIG. 6, the server does not need to perform multiple interactions with a terminal and does not need to traverse a file directory in the server layer by layer or compare the file directory in the server with a file directory in the terminal. In addition, compared with an entire directory structure of a file, a data volume of an operation record generated after the terminal latest synchronizes the file is relatively small, which not only shortens a data transmission time during synchronization but also can reduce consumption of a network resource of a user, thereby improving synchronization efficiency.

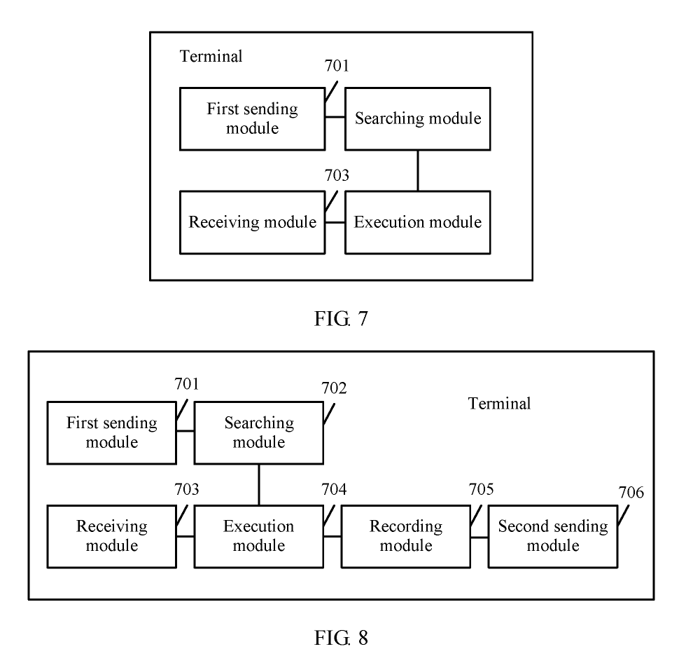

Referring to FIG. 7, FIG. 7 is a schematic diagram of a structure of an embodiment of a terminal according to the present application. As shown in FIG. 7, the terminal may include: a first sending module 701, a searching module 702, a receiving module 703, and an execution module 704.

The first sending module 701 is configured to send a file synchronization request to a server.

The searching module 702 is configured to search for second record data, where the second record data includes an operation record performed on a file after the terminal latest synchronizes the file.

The receiving module 703 is configured to receive first record data sent after the server responds to the file synchronization request, where the first record data includes an operation record generated, for the file of a predetermined version in data that is of various versions of the file and stored in the server, after the terminal latest synchronizes the file.

The execution module 704 is configured to obtain, according to the first record data and the second record data, an operation that should be performed by the terminal, and perform the operation.

In the present application, the terminal sends the file synchronization request to the server, where the file synchronization request may indicate a file that needs to be currently synchronized by the terminal, a time at which the terminal latest synchronizes the file, a version number of the file that is latest synchronized by the terminal, and/or data (including a directory structure and/or an operation record and the like) that needs to be provided by the server when the file is currently synchronized.

In the present application, the terminal may include two types: One type is a terminal that can directly acquire an operation record of the file, where the terminal of this type generally includes an input apparatus and a processor and can independently perform an operation on a file, for example, a computer and a tablet computer; the other one is a terminal that cannot directly acquire an operation record of a file, for example, a USB flash drive for synchronization.

Based on different types of terminals, correspondingly, the searching module 702 may also search for the second record data in different implementation manners.

In a possible implementation manner, when the terminal can directly obtain the operation record of the file, the searching module 702 may further include the following units (not shown in the figure):

a searching unit, configured to search for each operation record performed on the file after the terminal latest synchronizes the file.

The second record data is obtained by dividing or combining these operation records according to an operation path.

Specifically, the dividing refers to dividing an operation record that involves multiple paths into multiple basic operation records that involve only one path. For example, “MOVE A, f1 to f2” may be divided into “DELETE A, f1” and “ADD A, f2”. The combining refers to combining multiple operation records that have a same operation path into a relatively small quantity of operation records. For example, “ADD B, f1”, “ADD C, f1”, and “DELETE B, f1” may be combined into “ADD C, f1”. The division and combination operations can simplify data required during synchronization and remove redundant data, so as to shorten a synchronization time and improve synchronization efficiency.

In another possible implementation manner, when the terminal cannot directly acquire an operation record of a file, the step of searching for second record data by the searching module 702 may include: first, reading directory information of the file that is obtained and stored after the terminal latest completes synchronization of the file; then, comparing the directory information of the file that is obtained after the terminal latest completes synchronization of the file with directory information of the file that is currently and locally stored in the terminal, so that the operation record that is performed on the file after the terminal latest completes synchronization of the file can be obtained, where the operation record includes added data and/or deleted data, and the like, and the operation record is the second record data.

In specific implementation, based on different content of the file synchronization request, correspondingly, the first record data may also have several different cases.

In a possible implementation manner, the file synchronization request may include a version number of the file that is latest synchronized by the terminal and a latest version number for current synchronization. In this case, the first record data includes all operation records generated for the file of the predetermined version after the terminal latest synchronizes the file, where the predetermined version is all versions whose version numbers are from the version number of the file that is latest synchronized by the terminal to the latest version number for the current synchronization (including the latest version number for the current synchronization). Specifically, the latest version number for the current synchronization may be the latest version number of the current file, or may be any version number that is later than the version number of the latest synchronization, which may specifically depend on a current network status of the terminal.

In a possible implementation manner, the file synchronization request may include the version number of the file that is latest synchronized by the terminal and a quantity threshold. In this case, the first record data may include a predetermined quantity of operation records successively generated for the file of the predetermined version after the terminal latest synchronizes the file, where a version number of the predetermined version is later than the version number of the file that is latest synchronized by the terminal, and a value of the predetermined quantity is equal to the quantity threshold.

In specific implementation, the execution module 704 may obtain, by means of computing and with reference to the operation record generated, after a time point at which the terminal latest completes synchronization of the file, by the file that is of the predetermined version and stored in the server, and the operation record performed on the file by the terminal, the operation that needs to be performed during current synchronization, for example, data that needs to be added, and data that needs to be deleted.

In a possible implementation manner, the first record data sent by the server is multiple operation records that are directly found from data of various versions of the file by the server and have not undergone simplifying processing. In this case, the execution module 704 may include the following units (not shown in the figure): a second record simplifying unit and an execution unit.

The second record simplifying unit is configured to divide or combine the multiple operation records according to an operation path to simplify the first record data. Specifically, the dividing refers to dividing an operation record that involves multiple paths into multiple basic operation records that involve only one path, and the combining refers to combining multiple operation records that have a same operation path into a relatively small quantity of operation records. The division and combination operations can simplify data required during synchronization and remove redundant data, so as to shorten a synchronization time and improve synchronization efficiency.

The execution unit is configured to obtain, according to simplified first record data and the second record data, an operation that should be performed by the terminal, and perform the operation. In this case, if operation records in both the first record data and the second record data are basic operation records that involve only one operation path, the obtaining, according to the first record data and the second record data, the operation that should be performed by the terminal may be specifically: using the time point at which the terminal previously completes synchronization of the file as a start point; combining, in ascending order of operation time, operation records that are in the first record data and the second record data and have a same operation path; and obtaining, according to a combined operation record, the operation that should be performed by the terminal. For example, operation records whose operation paths are disk 1 (f1) are “ADD A, f1”, “ADD B, f1”, “ADD C, f1”, and “DELETE B, f1”, and the foregoing four operation records may be combined into “ADD AB, f1”; then, the operation that should be performed by the terminal is adding “AB” to the disk 1.

In some possible implementation manners, as shown in FIG. 8, the terminal may further include at least one of: a recording module 705 and a second sending module 706.

The recording module 705 is configured to record, after the execution module 704 obtains the operation that should be performed by the terminal and performs the operation, a latest version number of the file in the first record data as a version number for current synchronization of the file performed by the terminal.

The second sending module 706 is configured to send identification information of the terminal, the version number for the current synchronization of the file performed by the terminal, and a user identifier of the terminal to the server, so that the server updates a record of synchronization performed by a user on the terminal. In specific implementation, the record of synchronization performed by the user on the terminal may include the identification information of the terminal, the user identifier of the terminal, a time and version number of synchronizing the file, and the like.

In the terminal described in FIG. 7 or FIG. 8, a first sending module sends a file synchronization request to a server; a searching module searches for an operation record performed on a file after the terminal previously completes synchronization of the file and uses the operation record as second record data; a receiving module receives first record data sent by the server, so that the terminal does not need to perform multiple interactions with the server and does not need to traverse a file directory in the server layer by layer. In addition, the first record data includes some operation records, and compared with an entire directory structure of the file, a data volume is relatively small, which not only reduces a transmission time but also can reduce consumption of a network resource of a user. Before obtaining, according to the first record data and the second record data, an operation that should be performed by the terminal, an execution module may first divide and combine the first record data, so as to reduce redundant data and a computing amount during synchronization, thereby alleviating computing pressure on the terminal and improving synchronization efficiency.

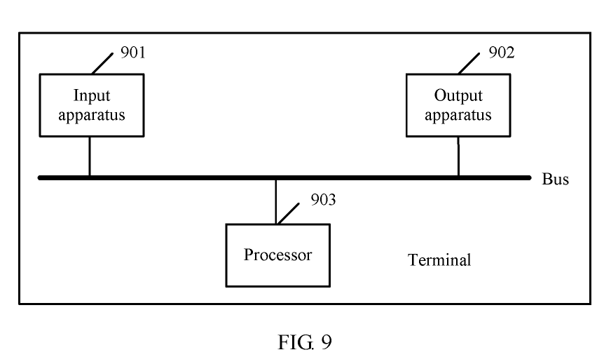

Referring to FIG. 9, FIG. 9 is a schematic diagram of a structure of still another embodiment of a terminal according to the present application. As shown in FIG. 9, the terminal may include: an input apparatus 901, an output apparatus 902, and a processor 903. In some embodiments of the present application, the input apparatus 901 and the processor 903, and the output apparatus 902 and the processor 903 may be connected through a bus or another means, and a connection through a bus is used as an example in FIG. 9.

The output apparatus 902 is configured to send a file synchronization request to a server.

The input apparatus 901 is configured to receive first record data sent after the server responds to the file synchronization request, where the first record data includes an operation record generated, for a file of a predetermined version in data that is of various versions of the file and stored in the server, after the terminal latest synchronizes the file.

The processor 903 is configured to:

search for second record data, where the second record data includes an operation record performed on the file after the terminal latest synchronizes the file; and

obtain, according to the first record data and the second record data, an operation that should be performed by the terminal, and perform the operation.

In a possible implementation manner, when the processor 903 searches for the second record data, specific steps are as follows:

searching for each operation record performed on the file after the terminal latest synchronizes the file; and

dividing or combining each operation record according to an operation path to obtain the second record data.

In a possible implementation manner, the first record data includes at least one operation record.

When the processor obtains, according to the first record data and the second record data, the operation that should be performed by the terminal, and performs the operation, specific steps are as follows:

dividing or combining the at least one operation record according to an operation path to simplify the first record data; and

obtaining, according to simplified first record data and the second record data, the operation that should be performed by the terminal, and performing the operation.

In a possible implementation manner, the processor 903 is further configured to record a latest version number of the file in the first record data as a version number for current synchronization of the file performed by the terminal.

The output apparatus 902 is further configured to send identification information of the terminal, the version number for the current synchronization of the file performed by the terminal, and a user identifier of the terminal to the server, so that the server updates a record of synchronization performed by a user on the terminal.

In the terminal described in FIG. 9, the terminal does not need to perform multiple interactions with a server and does not need to traverse a file directory in the server layer by layer or compare the file directory in the server with a file directory in the terminal. In addition, compared with an entire directory structure of the file, a data volume of an operation record generated after the terminal latest synchronizes the file is relatively small, which not only shortens a data transmission time during synchronization but also can reduce consumption of a network resource of a user, thereby improving synchronization efficiency.

It should be noted that, for brief description, the foregoing method embodiments are represented as a series of actions. However, a person skilled in the art should appreciate that the present application is not limited to the described order of the actions, because according to the present application, some steps may be performed in other orders or simultaneously. It should be further appreciated by a person skilled in the art that the embodiments described in this specification all belong to exemplary embodiments, and the involved actions and modules are not necessarily required by the present application.

In the foregoing embodiments, the description of each embodiment has respective focuses. For a part that is not described in detail in an embodiment, reference may be made to related descriptions in other embodiments.

A person of ordinary skill in the art may understand that all or some of the steps of the methods in the embodiments may be implemented by a program instructing relevant hardware. The program may be stored in a computer readable storage medium. The storage medium may include a flash memory, a read-only memory (Read-Only Memory, ROM), a random access memory (Random Access Memory, RAM), a magnetic disk, and an optical disc.

The foregoing describes a file synchronization method, a server, and a terminal in detail according to the embodiments of the present application. In this specification, specific examples are used to describe the principle and implementation manners of the present application, and the description of the embodiments is only intended to help understand the method and core idea of the present application. In addition, a person of ordinary skill in the art may, based on the idea of the present application, make modifications with respect to the specific implementation manners and the application scope. Therefore, the content of this specification shall not be construed as a limitation to the present application.

What is claimed is:

1. A file synchronization method, comprising:
receiving a file synchronization request sent by a terminal;
responding to the file synchronization request, and searching data that is of various versions of a file and stored in a server for first record data, wherein the first record data comprises an operation record generated for the file of a predetermined version after the terminal latest synchronizes the file; and
sending the first record data to the terminal, so that the terminal obtains, according to the first record data and second record data in the terminal, an operation that should be performed by the terminal, wherein the second record data comprises an operation record performed on the file after the terminal latest synchronizes the file.

2. The method according to claim 1, wherein the file synchronization request comprises a version number of the file that is latest synchronized by the terminal and a latest version number for current synchronization; and
the first record data comprises all operation records generated for the file of the predetermined version after the terminal latest synchronizes the file, wherein a version number of the predetermined version is later than the version number of the file that is latest synchronized by the terminal and is earlier than or equal to the latest version number for the current synchronization.

3. The method according to claim 1, wherein the file synchronization request comprises a version number of the file that is latest synchronized by the terminal and a quantity threshold; and
the first record data comprises a predetermined quantity of operation records successively generated for the file of the predetermined version after the terminal latest synchronizes the file, wherein a version number of the predetermined version is later than the version number of the file that is latest synchronized by the terminal, and a value of the predetermined quantity is equal to the quantity threshold.

4. The method according to claim 1, wherein after the sending the first record data to the terminal, the method further comprises:
receiving identification information of the terminal, a version number for the current synchronization of the file performed by the terminal, and a user identifier of the terminal that are sent by the terminal;
updating, according to the identification information of the terminal, the version number for the current synchronization of the file performed by the terminal, and the user identifier of the terminal, a record of synchronization performed by a user on the terminal;
querying for a version number of the file that is latest synchronized by another terminal of the user; and
if the version number for the current synchronization of the file performed by the terminal is earlier than the version number of the file that is latest synchronized by the another terminal of the user, deleting, from the data that is of the various versions of the file and stored in the server, an operation record generated before the file synchronization request is received.

5. A file synchronization method, comprising:
sending a file synchronization request to a server;
searching for second record data, wherein the second record data comprises an operation record performed on a file after a terminal latest synchronizes the file;
receiving first record data sent after the server responds to the file synchronization request, wherein the first record data comprises an operation record generated, for the file of a predetermined version in data that is of various versions of the file and stored in the server, after the terminal latest synchronizes the file; and
obtaining, according to the first record data and the second record data, an operation that should be performed by the terminal, and performing the operation.

6. The method according to claim 5, wherein the searching for second record data comprises:
searching for each operation record performed on the file after the terminal latest synchronizes the file; and
dividing or combining each operation record according to an operation path to obtain the second record data.

7. The method according to claim 5, wherein the first record data comprises at least one operation record; and
the obtaining, according to the first record data and the second record data, an operation that should be performed by the terminal, and performing the operation comprises:
dividing or combining the at least one operation record according to an operation path to simplify the first record data; and
obtaining, according to simplified first record data and the second record data, the operation that should be performed by the terminal, and performing the operation.

8. The method according to claim 5, wherein after the obtaining, according to the first record data and the second record data, an operation that should be performed by the terminal, and performing the operation, the method further comprises:
recording a latest version number of the file in the first record data as a version number for current synchronization of the file performed by the terminal; and
sending identification information of the terminal, the version number for the current synchronization of the file performed by the terminal, and a user identifier of the terminal to the server, so that the server updates a record of synchronization performed by a user on the terminal.

9. A server, comprising: an input apparatus, an output apparatus, and a processor, wherein the input apparatus, the output apparatus, and the processor are connected through a bus, wherein:
the input apparatus is configured to receive a file synchronization request sent by a terminal;
the processor responds to the file synchronization request, and searches data that is of various versions of a file and stored in the server for first record data, wherein the first record data comprises an operation record generated for the file of a predetermined version after the terminal latest synchronizes the file; and
the output apparatus is configured to send the first record data to the terminal, so that the terminal obtains, according to the first record data and second record data in the terminal, an operation that should be performed by the terminal, wherein the second record data comprises an operation record performed on the file after the terminal latest synchronizes the file.

10. The server according to claim 9, wherein the file synchronization request comprises a version number of the file that is latest synchronized by the terminal and a latest version number for current synchronization; and
the first record data comprises all operation records generated for the file of the predetermined version after the terminal latest synchronizes the file, wherein a version number of the predetermined version is later than the version number of the file that is latest synchronized by the terminal and is earlier than or equal to the latest version number for the current synchronization.

11. The server according to claim 9, wherein the file synchronization request comprises a version number of the file that is latest synchronized by the terminal and a quantity threshold; and
the first record data comprises a predetermined quantity of operation records successively generated for the file of the predetermined version after the terminal latest synchronizes the file, wherein a version number of the predetermined version is later than the version number of the file that is latest synchronized by the terminal, and a value of the predetermined quantity is equal to the quantity threshold.

12. The server according to claim 9, wherein
the input apparatus is further configured to receive identification information of the terminal, a version number for the current synchronization of the file performed by the terminal, and a user identifier of the terminal that are sent by the terminal; and
the processor is further configured to:
update, according to the identification information of the terminal, the version number for the current synchronization of the file performed by the terminal, and the user identifier of the terminal, a record of synchronization performed by a user on the terminal;
query for a version number of the file that is latest synchronized by another terminal of the user; and
if the version number for the current synchronization of the file performed by the terminal is earlier than the version number of the file that is latest synchronized by the another terminal of the user, delete, from the data that is of the various versions of the file and stored in the server, an operation record generated before the file synchronization request is received.

13. A terminal, comprising:
a first sending module, configured to send a file synchronization request to a server;
a searching module, configured to search for second record data, wherein the second record data comprises an operation record performed on a file after the terminal latest synchronizes the file;
a receiving module, configured to receive first record data sent after the server responds to the file synchronization request, wherein the first record data comprises an operation record generated, for the file of a predetermined version in data that is of various versions of the file and stored in the server, after the terminal latest synchronizes the file; and
an execution module, configured to obtain, according to the first record data and the second record data, an operation that should be performed by the terminal, and perform the operation.

14. The terminal according to claim 13, wherein the searching module comprises:
a searching unit, configured to search for each operation record performed on the file after the terminal latest synchronizes the file; and
a first simplifying unit, configured to divide or combine each operation record according to an operation path to obtain the second record data.

15. The terminal according to claim 13, wherein the first record data comprises at least one operation record; and
the execution module comprises:
a second simplifying unit, configured to divide or combine the at least one operation record according to an operation path to simplify the first record data; and
an execution unit, configured to obtain, according to simplified first record data and the second record data, the operation that should be performed by the terminal, and perform the operation.

16. The terminal according to claim 13, wherein the terminal further comprises:
a recording module, configured to record a latest version number of the file in the first record data as a version number for current synchronization of the file performed by the terminal; and
a second sending module, configured to send identification information of the terminal, the version number for the current synchronization of the file performed by the terminal, and a user identifier of the terminal to the server, so that the server updates a record of synchronization performed by a user on the terminal.

17. A terminal, comprising: an input apparatus, an output apparatus, and a processor, wherein the input apparatus, the output apparatus, and the processor are connected through a bus, wherein:
the output apparatus is configured to send a file synchronization request to a server;
the input apparatus is configured to receive first record data sent after the server responds to the file synchronization request, wherein the first record data comprises an operation record generated, for a file of a predetermined version in data that is of various versions of the file and stored in the server, after the terminal latest synchronizes the file; and
the processor is configured to:
search for second record data, wherein the second record data comprises an operation record performed on the file after the terminal latest synchronizes the file; and
obtain, according to the first record data and the second record data, an operation that should be performed by the terminal, and perform the operation.

18. The terminal according to claim 17, wherein when the processor searches for the second record data, specific steps are as follows:
searching for each operation record performed on the file after the terminal latest synchronizes the file; and
dividing or combining each operation record according to an operation path to obtain the second record data.

19. The terminal according to claim 17, wherein the first record data comprises at least one operation record; and
when the processor obtains, according to the first record data and the second record data, the operation that should be performed by the terminal, and performs the operation, specific steps are as follows:
dividing or combining the at least one operation record according to an operation path to simplify the first record data; and
obtaining, according to simplified first record data and the second record data, the operation that should be performed by the terminal, and performing the operation.

20. The terminal according to claim 17, wherein
the processor is further configured to record a latest version number of the file in the first record data as a version number for current synchronization of the file performed by the terminal; and
the output apparatus is further configured to send identification information of the terminal, the version number for the current synchronization of the file performed by the terminal, and a user identifier of the terminal to the server, so that the server updates a record of synchronization performed by a user on the terminal.
